(19) United States
(12) Patent Application Publication
(10) Pub. No.: US 2025/0211529 A1
(43) Pub. Date: Jun. 26, 2025

(54) METHOD FOR IMPLEMENTING AND EVALUATING TSN TRAFFIC SCHEDULING

(71) Applicant: NESTFIELD CO., LTD, Ansan-si (KR)

(72) Inventors: Seung Ho HONG, Seoul (KR); Junhui JIANG, Harbin (CN); Won Seok SONG, Yongin-si (KR)

(21) Appl. No.: 18/836,752

(22) PCT Filed: Jan. 10, 2023
(86) PCT No.: PCT/KR2023/000448

§ 371 Date: Mar. 14, 2025

(30) Foreign Application Priority Data
Feb. 22, 2022 (KR) 10-2022-0022968

(51) Int. Cl. H04L 47/10; H04L 45/02

(52) U.S. Cl. CPC H04L 47/10; H04L 45/02

(57) ABSTRACT

A time-sensitive network (TSN) standardized, maintained, and managed by the IEEE 802.1 Task Group improves the real-time and deterministic capabilities of Ethernet. However, traffic scheduling has not been standardized, and is being widely studied. Most research is essentially theoretical, and there are few practical verifications/research. In order to fill such a gap, the present invention provides detailed instructions for constructing an actual TSN-based process automation system first and regarding how a traffic scheduling method (TSM) will be distributed to industrial facilities. The present applicants empirically investigated the validity of a method according to the present invention and compared the performance thereof with that of a commercial TSN scheduler. The result shows that the method according to the present invention accurately schedules traffic such that robust real-time requirements are satisfied, and removes queuing delay, thereby accomplishing ultra-low latency.

### CROSS-REFERENCE TO RELATED APPLICATIONS

This application claims the benefit under 35 U.S.C. section 371, of PCT International Application No. PCT/KR2023/000448, filed on Jan. 10, 2023, which claims foreign priority to Korean Patent Application No. 10-2022-0022968, filed on Feb. 22, 2022, in the Korean Intellectual Property Office, both of which are hereby incorporated by reference in their entireties.

### TECHNICAL FIELD

The present invention relates to implementing and evaluating TSN (Time-Sensitive Networking) traffic scheduling, and in detail, relates to implementing TSN scheduling to industrial automation systems.

### Background

The Time-Sensitive Networking (TSN) is emerging as the principal technology for the next era of industrial communication. TSN exploits the excellent bandwidth and low cost of the Ethernet to compensate for real-time and deterministic capabilities using a series of enhanced standards. The IEEE 802.1 TSN Task Group develops and maintains these standards; examples include high-precision clock synchronization, bounded latency, ultra-reliability and flexible resource management.

TSN provides better standard compliance and vendor independence, and compatibility, than other Ethernet-based real-time communication technologies (e.g., EtherCAT, PROFINET, and Sercos III, and the like.). Due to the lower cost and ease of use, TSN networks can be readily scaled and integrated with other high-layer communication technologies (e.g., OPC UA).

Therefore, TSN plays key roles in the implementation of various industrial applications, and also contributes to the integration of information technology and operational technology in the industrial Internet of Things. TSN is not confined to industrial automation; it also plays pivotal roles in many other areas that demand real-time communication, such as in-vehicle networking, aerospace, an the like.

Earlier reports explored TSN in terms of time synchronization, simulation, resource management, and traffic scheduling. In one the prior studies, a TSN-based time synchronization method was presented that guarantees highly accurate clock synchronization across EtherCAT nodes. To extend TSN to wireless networks, a novel, high-precision, wireless time synchronization strategy was developed.

In one of other prior studies, the clock synchronization accuracy of IEEE 802.1AS was tested by deploying it in a practical industrial system. The major factors (PHY jitter and clock granularity) that affect clock accuracy were analyzed. In yet one of other prior studies modeled the IEEE 802.1 Qbv using an OMNET++ simulator. These studies also further validated the simulation in a real-world TSN testbed.

An OPC UA TSN configuration architecture was proposed and validated in a laboratory-level manufacturing system in one of these prior studies. In another study, an SDN-based self-configuration framework was presented to automatically configure TSN networks. Simulations indicated that TSN networks with different topologies were appropriately configured.

Application of TSN to traffic scheduling remains challenging. Optimization theories such as Satisfiability Modulo Theories (SMT) and integer linear programming (ILP) have been widely applied. In the prior stuies, an SMT model and an array theory were used to formalize scheduling constraints. In one of the other prior studies presented a no-wait scheduling algorithm using an SMT-based optimal modulus theory. Other one of these prior studies applied TSN to virtual machine (VM)-based control networks, and presented a lightweight heuristic algorithm for traffic scheduling. ILP-based approaches have also been explored. In one the prior studies, an ILP-based algorithm was used to schedule new TSN traffic entering a system. A commercial ILP solver (CPLEX) was used to solve the proposed formulations. Other one of these prior studies presented an ILP-based degree of conflict (DoC)-aware iterative routing and scheduling algorithm for large-scale time-sensitive networks. Yet other one of the prior studies developed ILP formulations that modeled the joint routing and scheduling problems, and explored runtime limitations using a state-of-the-art ILP solver and various inputs.

All of the studies described above found that optimization theory solved TSN scheduling problems. However, as the number of inputs increased, runtime increased dramatically, complicating practical implementation in industrial systems. Different from optimization theory, the inventors invented a traffic scheduling method (TSM) using the bandwidth allocation concept. Most previous studies focused on the theory of TSN scheduling via simulation, and no scheduling algorithm has yet been deployed in a real-world manufacturing scenario. Very few studies validated the theoretical approach by practical implementation. One of the studies performed a proof-of-concept experiment when evaluating the performance of IEEE 802.1Qbv. In another study, the off-the-shelf TSN devices available from different vendors were summarized. In yet antoerh study, a Z3 SMT solver was used as the core component of Slate XNS software for scheduling. Thus, these studies performed practical TSN research. However, the studies were concerned only with proof of the TSN standards and a description of the hardware solutions. Although other studies validated algorithms using an experimental testbed, neither practical industrial applications nor device diversity were considered. Specifically, only end stations transmitting or receiving TSN traffic were evaluated. Several key components of any practical control system (controllers, sensors, and actuators) were lacking. Thus, the practical feasibility of TSN scheduling remains to be proven. Also, the three cited works lacked technical details; neither algorithm implementation nor TSN testbed development was described.

### DETAILED DESCRIPTION OF THE INVENTION

### Problems to be Solved

The present invention has been developed by considering the above situation, and an object of the present invention relates to developing a TSM for TSN (Time-Sensitive Networking), and deployed it in the real world.

Other object of the present invention is to explore various experimental results to analyze the practical feasibility of the TSM.

### Means to Solve the Problem

In order to solve the problems, the method of the present invention is performed in a control device of an industrial automation system, and includes a step for network partitioning that divides the network into subnetworks and adjusts the traffic flow specification based on the network topology (G), traffic flow specification (F) and routing path (p_{(src}_{ᵢ}_{,dst}_{ⱼ}₎, and a step for scheduling that determines the Gate Control List (GCL) to open or close the switch (SW) on the routing path in a predetermined time, and the message transmission start instant (FMTIᵢ^{src}^{ᵢ}) for each traffic flow, based on the subnetwork (G′) and the adjusted traffic flow (F′), and link specification (link speed and length).

The apparatus of the present invention is a control apparatus for an industrial automation system includes a Central Network Configurator (CNC) that generates the Gate Control List (GCL) that determines the Gate Control List (GCL) to open or close the switch (SW) on the routing path in a predetermined time, and the message transmission start instant (FMTIᵢ^{src}^{ᵢ}) for each traffic flow. The control apparatus also includes a Central User Configurator (CUC) that controls the message transmission operation of the transmitter after receiving the message transmission instant of the transmitter from the network configurator.

### Effect of the Invention

As described above, the present invention constructs a realistic TSN system in which the robotic process automation scenario is used to verify the effectiveness of the TSM scheduler.

The real-time performance of the TSM of the present invention was compared to a commercial scheduler, and proved that the TSM guarantees the strict real-time requirements of an industrial robotic application, eliminated queuing delay, and afforded ultra-low latency.

The TSM of the present invention is capable of scheduling 500 flows in milliseconds, more than 571-fold faster than the commercial scheduler. That is, the TSM of the present invention has an effect of quickly processing the reconfigurations required with changes in network infrastructure or custom-oriented applications in the context of Industry 4.0.

### BRIEF DESCRIPTION OF THE DRAWINGS

FIG. 1: an example TSN Network.

FIG. 2: a bandwidth allocation system for egress of an arbitrary SWₖ.

FIG. 3: a system architecture.

FIG. 4: a procedure flowchart for CNC and CUC.

FIG. 5: a sequencing of the configuration procedure.

FIG. 6: a real-word TSN-based process automation system.

FIG. 7: an illustration of time-slot allocation of Table 3 and Table 2.

FIG. 8: an end-to-end latency (Tₑ₂ₑ) comparison: TSM and Cisco CNC results.

FIG. 9: a comparison of scheduling performance with different delay constraints.

FIG. 10: a calculation time (T_{cal}) of TSM and Cisco CNC for real-world testbed

FIG. 11: a calculation time (T_{cal}) comparison for TSM and Cisco CNC.

FIG. 12: a scheduling procedure in an industrial automation system.

FIG. 13: a schematic configuration of the control system of an industrial automation system.

### DETAILED DESCRIPTION TO EXECUTE THE INVENTION

Hereinbelow, embodiments of the present invention will be described in detail while referring to the accompanying drawings. The configuration and effects of action of the present invention will be understood clearly through the detailed description below.

The present invention is organized as presenting the network model, key principle of TSM (Traffic Scheduling Method), practical traffic scheduling and system configuration for a real-world industrial facility, and performance evaluation.

### Network Model

A TSN topology is modeled as a directed weighted graph G≡(V,E). Here, V is the set of network nodes and E={(vᵢ,vⱼ)|vᵢ, vⱼ∈V} is a set of all directional links of source vᵢ and destination vⱼ.

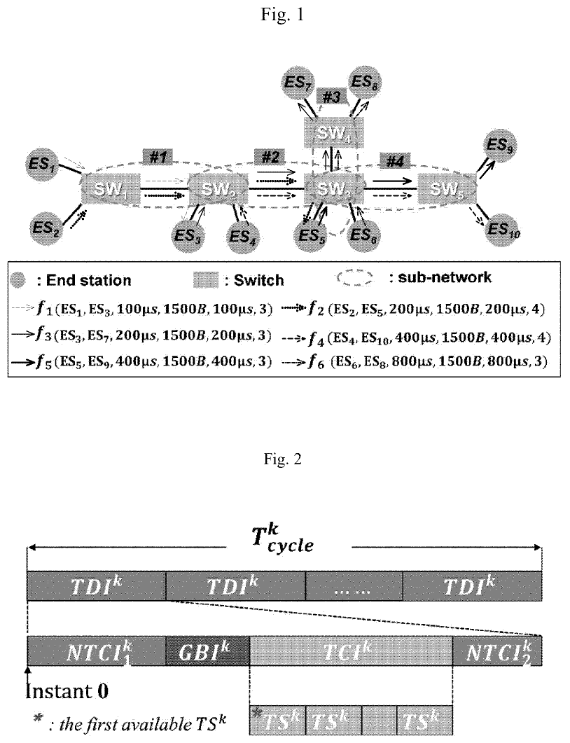

V=(SW∪ES), where SW and ES denote the TSN switches and end stations respectively. An example TSN network topology is shown in FIG. 1, in which SW={SWᵢ|i=1 . . . 5} and ESⱼ={ESⱼ|j=1 . . . 10}. The SW s and ESs are synchronized via 802.1AS and equipped with a time-aware shaper (TAS) for traffic scheduling, as defined in 802.1Qbv. Specifically, the TAS has eight prioritized queues with time-aware gates. Using a gate control list (GCL), the TAS schedules traffic by opening or closing gates at specific times. The GCL is calculated by the central network configurator (CNC) and configured to the SWs before the system runs. The real-time applications are executed by the ESs, which generate a set of time-critical (TC) flows F.

Each flow fᵢ ∈F is characterized by a tuple (srcᵢ,dstᵢ,pᵢ,lᵢ,φᵢ,hopᵢ^{v}^{ⱼ}), where srcᵢ ∈ES is the source, dstᵢ∈ES is the destination, pᵢ is the transmission period, lᵢ is the traffic size, φᵢ is the delay constraint (i.e., maximum allowable delay), and hopᵢ^{v}^{ⱼ} is the hop-count from srcᵢ to the node vⱼ(vⱼ∈V).

To guarantee real-time performance, an fᵢ must be transmitted from srcᵢ to dstᵢ within φᵢ. The flow specifications of the example topology are illustrated at the bottom of FIG. 1.

Here, F={f₁,f₂,f₃,f₄,f₅,f₆},

f₁=(ES₁,ES₃,100 μs,1500B,100 μs, 3), and so on.

It is noted that the last element of flow specifications shown in FIG. 1 is the hop-count hopᵢ^{dst}^{ᵢ} from srcᵢ to dstᵢ, i.e., vⱼ=dstᵢ. The routing path p₍ᵥ_{ᵢ}_{,v}_{ⱼ}₎^{f}^{ᵢ} is an ordered sequence of all interconnected nodes along the forwarding path of fᵢ from source vᵢ to destination vⱼ. For example, as shown by the thin dashed arrows in FIG. 1, the path of f₁ from ES₁ to ES₃ is p_{(ES}_{₁}_{,ES}_{₃}₎^{f}^{₁}={[ES₁,SW₁,SW₂,ES₃]}.

### Key Principles of a TSM

The inputs are the network topology G, TC flows F, and link specifications (length L₍ᵥ_{ᵢ}_{,v}_{ⱼ}₎ and speed S₍ᵥ_{ᵢ}_{,v}_{ⱼ}). The outputs are the GCLs for the TSN switches and the startup instants of traffic transmission for all TSN talkers. Essentially, the TSM contains two routines: Network Partition to enhance scalability, and Traffic Scheduling to guarantee real-time performance.

### Network Partition

The Network Partition routine applies the scheduling to be described below to the subnetworks of a large-scale TSN. Any arbitrary TSN network G can be partitioned into several subnetworks G′ which does not have any branches. For example, in FIG. 1, the network is split into four subnetworks: G′={(SW₁,SW₂), (SW₂,SW₃), (SW₃,SW₄), (SW₃,SW₅)}. Each subnetwork G′ contains N inputs fᵢ, N outputs fᵢ, and K TSN SWs in series. Accordingly, the maximum allowable delay φᵢ^{L} of fᵢ in the L-th subnetwork G′_{L} is represented by Equation 1.

$${φ}_{i}^{L} = ⌈ {φ}_{i} \times \frac{K - 1}{M - 1} ⌉ \qquad [ Equation 1 ]$$

Here, L is the subnetwork index, K is the number of SWs in G′_{L}, and M is the total number of SWs along p_{(src}_{ᵢ}_{,dst}_{ᵢ}₎^{f}^{ᵢ}. If the real end-to-end latency of the fᵢ of each subnetwork does not exceed φᵢ^{L}, the total maximum allowable delay requirement φᵢ is satisfied.

### Traffic Scheduling

The basic concept of Traffic Scheduling is to divide the available bandwidth into time slots via time-division multiplexing. Next, two separate intervals (i.e., time-critical interval and non-time-critical interval) are assigned to TC and non-TC traffic flows, which eliminates the transmission interference from non-TC to TC traffic flows. A time-critical interval is further subdivided into multiple individual time slots, which are allocated to individual TC traffic flows. This allocation guarantees the independent transmission of different TC flows without any interference with each other. Therefore, the maximum allowable delay requirement is satisfied and no flow experiences a queuing delay. The inputs to traffic scheduling are the specifications of the flows transmitted within each subnetwork, and the outputs are the TSN schedules. With Network Partition, each φᵢ must be adjusted to φᵢ^{L} μsing equation 1. In the L-th subnetwork G′_{L}, Φ is the vector of φᵢ^{L}(∀i=1, . . . , N), the elements of which are sorted in ascending order as represented by Equation 2.

Φ=[φ₁^{L}, . . . ,φᵢ^{L}, . . . ,φ_{N}^{L}],(φᵢ^{L}≤φ_{I+1}^{L}),∀i=1, . . . ,N−1 [Equation 2]

Next, the fundamental principles of Traffic Scheduling is summarized.

Step 1: Determine the time-division interval (TDI^{k}) for SWₖ egress. The TC flows, fᵢ, and non-TC flows compete for bandwidth resources at the time of SWₖ egress.

As shown in FIG. 2, to guarantee the real-time performance of fᵢ, the shared bandwidth is divided into multiple time-division intervals. Here, instant 0 is regarded as the start of the TSN schedule. The length of all the TDI^{k} values sums to the so-called “hyper-period” (T_{cycle}^{k}). Scheduling is repeated at intervals of T_{cycle}^{k}. Generally, each TDI^{k} is further split into the guard band interval (GBI^{k}), a TC interval (TCI^{k}), and two non-TC intervals [the first non-TC interval (NTCI₁^{K}) and the second non-TC interval (NTCI₂^{k})]. The TCI^{k} has multiple time slots (TS^{k}) dedicated to transmission of fᵢ. The GBI^{k} is always reserved immediately before TCI^{k} to prevent transmission interference from non-TC flows. NTCI^{k} is allocated before TCI^{k} and NTCI₂^{k} is allocated after TCI^{k}. Then, the lengths of TDI^{k}, GBI^{k}, and NTCI^{k} are determined.

The TDI^{k} is the basic scheduling unit for SWₖ, the length of which is determined by Equation 3, where φₘᵢₙ is the smallest maximum allowable delay. Equation 3 guarantees real-time performance by restricting the length of TDI^{k} to φₘᵢₙ.

$${TDI}^{k} = {φ}_{min} \qquad [ Equation 3 ]$$

As defined in 802.1Qbv, GBI^{k} is the duration of maximum transmission unit (MTU)-size frame transmission, and is thus determined by Equation 4, where Lₘₜᵤ is the MTU size, and S₍ᵥ_{ᵢ}_{,v}^{j}) is the link speed:

$${GBI}^{k} = \frac{{L}_{m t u}}{{s}_{( {v}_{i} , {v}_{j} )}} \qquad [ Equation 4 ]$$

Next, the length of NTCI^{k} is determined. The sum of NTCI₁^{k} and GBI^{k} is equal to the network delay (D_{phy}^{src}^{ᵢ}^{ToSW}^{ₖ}) experienced by fᵢ. Thus, as soon as fᵢ arrives at SWₖ, it will be immediately transmitted during TCI^{k}. D_{phy}^{src}^{ᵢ}^{ToSW}^{ₖ} equals to Equation 5.

$${D}_{phy}^{{src}_{i} {ToSW}_{k}} = {\sum }_{j = 1}^{{M}_{i} + 1} {d}_{trans} + {\sum }_{j = 1}^{{M}_{i} + 1} {d}_{prop} + {\sum }_{j = 1}^{{M}_{i}} {d}_{proc} \qquad [ Equation 5 ]$$

Here, Mᵢ is the number of SWs between srcᵢ and SWₖ. The transmission delay (dₜᵣₐₙₛ) and propagation delay (dₚᵣₒₚ) can be simply calculated. It is assumes that the processing delay (d_{proc}) of a switch is an input. Then, the NTCI₁^{k} is given by Equation 6, where GBI^{k} and D_{phy}^{src}^{ᵢ}^{ToSW}^{ₖ} are determined by Equation 4 and Equation 5, respectively:

$${D}_{phy}^{{src}_{i} {ToSW}_{k}} = {NTCI}_{1}^{k} + {GBI}^{k} \qquad [ Equation 6 ]$$

Step 2: Determine the time-slot allocation interval (TSAIᵢ) and number of time slots (TSTCD^{k}) allocated to TCI^{k}. To eliminate queuing delay, the maximum allowable delay requirement for input fⁱ is harmonized first, and then allocate the appropriate time slots. Specifically, let TSAI be the vector, the elements of which are sorted in ascending order of TSAIᵢ as represented by Equation 7.

TSAI=[TSAI₁, . . . ,TSAIᵢ, . . . ,TSAI_{N}],(TSAIᵢ≤TSAIᵢ₊₁) [Equation 7]

TSAI₁ is the smallest TSAIᵢ, and should equal the length of the TDI^{k} defined by Equation 8.

TSAI_1=TDI\hat{ }k=φ_1 [Equation 8]

The definition of Equation 8 guarantees that the most urgent TC traffic does not exceed its maximum allowable delay requirement. Therefore, all delay requirements are satisfied. Then, the window scheduling algorithm is adopted to calculate the TSAIᵢs (∀i=2, . . . , N) as represented by Equation 9.

$${TSAI}_{i} - {k}_{i} \times {TSAI}_{1} , {k}_{i} = {2}^{⌊ {log}_{2} ( {φ}_{i} / {TSAI}_{1} ) ⌋} \qquad [ Equation 9 ]$$

The first term in Equation 9 indicates that each TSAI; is derived by multiplying an integer kᵢ by TSAI₁. kᵢ is defined as a power of two (2^{m}) where m is the floor function m (x)=└x┘. As denoted in Equation 9, the maximum time-slot allocation interval TSAIₘₐₓ is the least common multiple of the TSAIᵢ, and is thus equal to the hyper-period T_{cycle} mentioned above. In other words, TSN scheduling is repeated at intervals of TSAIₘₐₓ. The time slots (TSTCD^{k}) allocated to TCI^{k} are represented by Equation 10.

$${TSTCD}^{k} = ⌈ {\sum }_{i = 1}^{N} ( {TDI}^{k} / {TSAI}_{i} ) ⌉ \qquad [ Equation 10 ]$$

To ensure that all TSTCDK values are integers, Equation 10 rounds up the formula Σᵢ₌₁^{N}(TDI^{k}/TSAIᵢ), which expresses the average number of time slots allocated to fᵢ during a TDI^{k}. Then, the length of TCI^{k} is determined as represented by Equation 11.

$${TCI}^{k} = {TSTCD}^{k} \times \frac{{L}_{frame}}{{s}_{( {v}_{i} , {v}_{j} )}} \qquad [ Equation 11 ]$$

Here,

$$\frac{{L}_{frame}}{{s}_{( {v}_{i} , {v}_{j} )}}$$

is the time taken to transmit fᵢ, L_{frame} is the frame size, and S₍ᵥ_{ᵢ}_{,v}_{ⱼ}₎ is the link speed. At this point, for a TDI^{k}, the length of the GBI^{k}, the NTCI^{k}, and the TCI^{k} have been determined. The remaining bandwidth is allocated to NTCI₂^{k}, the length of which is represented by Equation 12.

$${NTCI}_{2}^{k} = {TDI}^{k} - ( {NTCI}_{i}^{k} + {GBI}^{k} + {TCI}^{k} ) \qquad [ Equation 12 ]$$

NTCI₂^{k} decreases as the input TSN flow increases. However, NTCI₂^{k} cannot become negative, because the number of input flows cannot increase infinitely (the bandwidth is finite). If too many fᵢ are input, the bandwidth will be overloaded. To avoid this, the number of input TSN flows must not exceed the maximum bandwidth. In other words, the length of NTCI₂^{k} must be restricted as represented by Equation 13.

NTCI₂^{k}≥0 [Equation 13]

Then, according to Equation 12 and Equation 13, the stability condition becomes Equation 14, which guarantees that the fᵢ are scheduled appropriately.

$${TDI}^{k} \geq {NTCI}_{1}^{k} + {GBI}^{k} + {TCI}^{k} \qquad [ Equation 14 ]$$

Step 3: Allocate a specific time slot to fᵢ, and determine the starting instant of the first message sent from a talker (FMTIᵢ^{src}^{ᵢ}) and a switch (FMTIᵢ^{SW}^{ₖ}). Here, the sequence of time-slot allocation is determined from the fᵢ with the smallest delay requirement to that with the largest requirement. Specifically, the fᵢ with φ₁ is allocated to the first available time slot in the first TDI^{k} (marked with an asterisk in FIG. 2). Then, the remaining fᵢ with φᵢ values (∀i=2, . . . , N) are subsequently allocated to the next available time slot, and so on. When fᵢ is scheduled at SWₖ, FMTIᵢ^{SW}^{ₖ} becomes Equation 15.

$${FMTI}_{i}^{{SW}_{k}} = ( m - 1 ) \times {TDI}^{k} + ( {NTCI}_{1}^{k} + {GBI}^{k} ) + ( n - 1 ) \times {TS}^{k} \qquad [ Equation 15 ]$$

Here, m and n are the indexes of TDI^{k} and TS^{k}, respectively. Equation (15) gives the instant at which fᵢ is to be transmitted out from egress of SWₖ. Before fᵢ arrives at the egress, it experiences a delay along its forwarding path p_{(src}_{ᵢ}_{,SW}_{ₖ}₎^{f}^{ᵢ}. Therefore, after backtracking by that amount of time, it is determined that the FMTIᵢ^{src}^{ᵢ} is represented by Equation 16.

$${FMTI}_{i}^{sr {c}_{i}} = {FMTI}_{i}^{{SW}_{k}} - {D}_{phy}^{{src}_{i} {ToSW}_{k}} \qquad [ Equation 16 ]$$

Here, D_{phy}^{src}^{ᵢ}^{ToSW}^{ₖ} is the network delay from srcᵢ to SWₖ, as determined by Equation 5.

Step 4: Generate the TSN schedule (i.e., the GCL). The GCL instructs the TAS to open or close a gate at a specific instant and retain that gate status for a certain time. Three key parameters are required:

1. The instant of gate opening to allow transmission of fᵢ.

The FMTIᵢ^{src}^{ᵢ} and FMTIᵢ^{SW}^{ₖ}, as determined in Step 3, inform the talkers or switches when to start transmission.

2. The duration of gate opening, which must allow complete traffic transmission.

As shown in Steps 1 and 2, TCI^{k}, NTCI^{k}, and NTCI^{k} are the intervals available for transmission of fᵢ and non-TC flows, respectively. The GBI^{k} is constructed to avoid transmission interference from non-TC flows. The gate is opened at the beginning of each interval and closed at the end.

3. The cycle time of a GCL.

The GCL is repeated at intervals of the TASIₘₐₓ determined in Step 2.

### Implementation Methodology

Descriptions are now made on the fine-grained guidelines for the implementation of Scheduling Procedure and Configuration agent, which are two crucial components for a TSN-based process automation system.

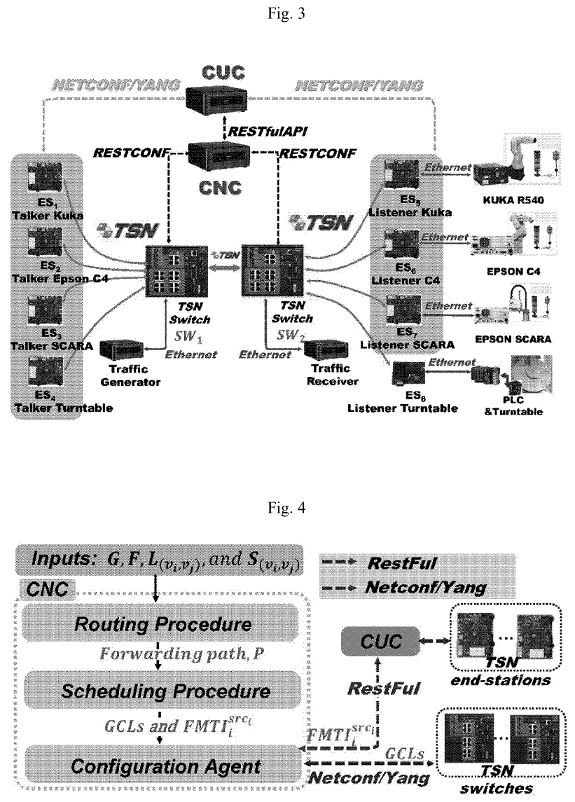

As illustrated in FIG. 3, a system architecture is constructed based on a fully centralized model. Specifically, this is the TSN network G={(ESᵢ,SWⱼ)|i=1, . . . ,8, j=1,2} where SW₁ and SW₂ are interconnected; ES₁, ES₂, ES₃, and ES₄ are TSN talkers, and ES₅, ES₆, ES₇, and ES₈ are listeners. The hardware deployment and application scenario will be detailed later.

Two primary system components have been developed in the embodiments of the present invention: a centralized network configurator (CNC) and a centralized user configurator (CUC). The CNC calculates forwarding paths and schedules for the TSN ESs and SWs. The CUC is responsible for central maintenance of traffic information and the configuration parameters of all TSN ESs.

To clarify how the CNC and CUC are developed, a flowchart is presented in FIG. 4. The CNC inputs are highlighted in grey; these are the network topology G, sets of TC flows F, link length L₍ᵥ_{ᵢ}_{,v}_{ⱼ}₎, and speed S₍ᵥ_{ᵢ}_{,v}_{ⱼ}₎.

The CNC blocks are the three internal CNC routines, i.e., the Routing procedure, Scheduling procedure, and Configuration agent. A well-known shortest path algorithm has been used as the Routing procedure. Then, the forwarding paths are calculated and input to the Scheduling procedure, wherein the TSM as described above is implemented de novo. The outputs of the Scheduling procedure are GCLs and FMTIᵢ^{src}^{ᵢ} configured for TSN devices. The FMTIᵢ^{src}^{ᵢ} is utilized by the CUC to configure TSN ESs, whereas the GCLs are configured to SWs by the CNC. This procedure is based on the NETCONF (Network Configuration Protocol) and YANG (Yet Another Next Generation) protocols, which centrally manage the configurations for network devices. Moreover, NETCONF is proposed in RFC 6241 that adopts a simple Remote Procedure Call (RPC) mechanism to acquire and modify the configurations of network devices. YANG is a data modeling language published in RFC 7950 that defines the configuration data, state data, and RPC for network devices. YANG instances can be encoded into XML format and extracted by NETCONF to configure network devices. Scheduling and configuration implementation are discussed below.

### Scheduling Procedure

The TSM has been implemented to be Scheduling Procedure, which uses the two routines of Network partition and Traffic scheduling. In general, Network partition obtains and processes inputs by partitioning network G into several subnetworks G′ with no branches. Then, the routine adjusts the input parameters (e.g., the maximum allowable delay requirement φᵢ) for G′. Finally, G′ and the adjusted parameters are input to Traffic scheduling, which executes a four-step process to calculate the TSN schedule. The details are described below.

### Network Partition

Procedure 1 Network Partition

| Inputs: G, F, and P_{(src}_{ᵢ}_{,dst}_{ᵢ}₎^{f}^{₁} | |
|---|---|
| Output: G′ and F′ | |
| 1: | branchNodes ← Obtain branch nodes(G) |
| 2: | G′ ← Partition network(branchNodes, P_{(src}_{ᵢ}_{,dst}_{ᵢ}₎^{f}^{₁}) |
| 3: | F′ ← Adjust inputs(F, G′) |
| 4: | return G′ and F′ |

As shown in Procedure 1, Network Partitions generally contains three subfunctions including Obtain branch nodes, Partition network and Adjust inputs.

In particular, line 1 indicates that the routine of obtain branch nodes uses the input topology G to find out the branch nodes. The branch nodes are switch nodes and represented by “branchNodes={(Swi)|Swi⊆SW}”.

The branchNodes are the breakpoints at which network G is divided into various G′ without any branches. To achieve this, each element of branchNodes should be interconnected via two switches, and to either end stations or switches. To find all elements of branchNodes, Obtain branch nodes implements a filter, as follows:

1) Filter a switch node connected with N switches (N≥3) and M end stations (M≥ 0).

2) Filter a switch node connected with M TSN end stations (M≥1) and N switches (N=2).

For example, the topology of FIG. 1 is input and the routine of obtain branch nodes is executed.

The branchNodes are {SW₂,SW₃} because SW₃ is connected to three switches (filter rule 1), and SW₂ to two end stations (filter rule 2). This guarantees that each subnetwork does not has any branch (i.e., the number of input and output flows are the same) if the network is split at the points of the branchNodes.

After defining the branchNodes, Partition network splits the network (line 2) by checking whether the forwarding path (p_{(src}_{ᵢ}_{,dst}_{ᵢ}₎^{f}^{ᵢ}) contains the branchNodes. If an element of branchNodes is detected, the network is split into two subnetworks at the point corresponding to that element of branchNodes. For example, the forwarding path of f₂ is P_{(ES}_{₂}_{,ES}_{₅}₎^{f}^{₂}={[ES₂,SW₁,SW₂,SW₃, ES₅]} and the branchNodes are {SW₂,SW₃} (as determined above). Hence, along p_{(ES}_{₂}_{,ES}_{₅}₎^{f2}, the network is split into two subnetworks, [i.e., {(SW₁,SW₂), (SW₂,SW₃)}]. By repeating this process, the whole network is eventually split into the four subnetworks indicated by the dashed circles in FIG. 1.

After execution of Partition network, the flow specifications are adjusted (line 3). The maximum allowable delay requirements (φᵢ values) are adjusted using equation 1, and then input into the scheduling function. For example, in FIG. 1, the φ₂ of f₂ is 200 μs, the number of SWs involved in the first subnetwork {(SW₁,SW₂)} is two, and the number of SWs along the forwarding path is three. Thus, the adjusted maximum allowable delay φ₂¹ is 100 μs using equation 1. Finally, G′ and F′ are obtained and input into the scheduling functions.

### Traffic Scheduling

Procedure 2 Traffic Scheduling

```
Inputs: G′, F′, S(ᵥ_{ᵢ}, ᵥ_{ⱼ}), and L(ᵥ_{ᵢ}, ᵥ_{ⱼ})
Output: GCLs and FMTIᵢ^{src}^{ᵢ}
  1: numflow ← len(F′)
  2: Φ ← heapsort(φᵢ′, F′)
    // Step 1: Determine the time-division intervals;
  3: TDI ← φ₁′
  4: GBI ← Use Bq. (4)
    // Step 2: Determine allocation interval, numbers of time slots
  5: TSAI₁ ← TDI
  6: TSAIᵢ ← Use Eq. (9)
  7: T_{cycle} ← max(TSAIᵢ)
  8: TSTCD ← Use Eq. (10)
  9: TCI ← Use Eq. (11)
10: numTDI ← T_{cycle}/TDI
11: numTS ← numTDI × TSTCD
12: availableTS ← numTS * [−1]
13: if TDI < NTCI₁ + GBI + TCI then
14:  return error
15: end if
    // Step 3: Allocate specific time slots to fᵢ
16: FMTIᵢ^{src}_{ᵢ} ← numflow * [0]
17: for F′ is not empty do
18:  fᵢ = (srcᵢ, dstᵢ, pᵢ, lᵢ, hopᵢ^{k}, φᵢ′) ← heappop(F′)
19:  D_{phy}^{talkerToSW}^{ₖ} ← Usc Eq. (5) with input hopᵢ^{k}.
20:  NTCI₁^{k} ← Use Eq. (6)
21:  for SWₖ in G′ do
22:  index AvaliableTS ← availableTS.FindIndex(−1)
23:  m ← ceil (index AvaliableTS/TSTCD)
24:  n ← indexAvaliableTS mod TSTCD
25:  FMTIᵢ^{SW}^{ₖ} Use Eq. (15) with inputs m, n.
26:  fmtiᵢ^{talker} ← Use Eq. (16) with input FMTIᵢ^{SW}^{ₖ}.
27:  if fmtiᵢ^{src}^{ᵢ} = = fmtiⱼ^{src}^{ᵢ} in FMTIⱼ^{src}^{ᵢ} then
28:  indexAvaliableTS ← IndexAvaliableTS + 1;
29:  Go to Line 22.
30:  end if
31:  FMTIᵢ^{src}^{ᵢ} ← fmtiᵢ^{src}^{ᵢ}
32:  requiredTS ← T_{cycle}/TSAIᵢ
$33. slotInterval ← ( TSTCD \times \frac{{T}_{cycle}}{TDI} ) / required TS$
34:  allocateCNT ← 0
35:  for allocateCNT < requiredTS do
36:  availableTS[indexAvaliableTS] ← fᵢ
37:  allocateCNT ← allocateCNT + 1
38:  indexAvaliableTS ← indexAvaliableTS +
              slotInterval
39:  end for
40:  end for
41: end for
    // Step 4: Output the results
42: Generate GCLs.
```

Traffic scheduling for TSN has been implemented by Procedure 2, where the four scheduling steps are marked with //. In detail, line 1 utilizes the function len( ) to obtain the length of F′, which is shown as the number (numflow) of fᵢ. Then, F′ is sorted using the heapsort method in ascending order of φᵢ′, and the ordered φᵢ′ are contained in Φ. The time-division intervals (i.e., Step 1 of Traffic Scheduling) are determined by lines 3 and 4. Specifically, the basic scheduling unit TDI is updated by the smallest value (φ₁′) of all φᵢ′. Then, the length of GBI is determined using equation (4).

Step 2 is implemented by lines 5-15. First, the allocation interval TSAIᵢ is determined. The smallest value of TSAIᵢ is the first element (TSAI₁) in TSAI, which is updated by TDI in line 5. Then, the other TSAIᵢ values are gradually calculated by equation (9). After all TSAI; have been determined, the maximum value is updated to T_{cycle}, at which time the TSN schedule is repeated. Next, TSTCD and the length of TCI are calculated in lines 8 and 9. The variable numTDI denoting the number of TDI in one hyper-period (a T_{cycle}), is updated by T_{cycle}/TDI. numTDI will always be an integer [see equations (8) and (9)]. The number (numTS) of time slots that can be contained in one T_{cycle} is calculated in line 11. Line 12 initializes a tuple availableTS of length numTS; this reflects the time-slot occupancy. All elements are initialized to −1 when all time slots are available. During time slot allocation, an arbitrary element of availableTS (e.g., i-th element) can be changed to a positive integer j, indicating that a flow with ID of j occupies the i-th slot.

For example, availableTS=[1,−1,−1,2] indicates that numTS is 4, the first and fourth time slots are allocated to f₁ and f₂, respectively; the second and third time slots are available for other flows. Lines 13-15 maintain the stability of the TSN system by guaranteeing inequality (14). If the stability condition is not satisfied, the scheduling procedure is terminated by error. In this case, the network engineer must reduce the input fᵢ by reference to the maximum bandwidth constraint.

It is noted that all SW s involved in the same subnetwork share the parameters calculated in Steps 1 and 2. As no subnetwork contains a branch, the numbers of input and output flows are the same. In other words, the calculation (lines 1-15) is only executed once for each subnetwork; this dramatically reduces the time needed to schedule traffic.

Step 3 of Traffic Scheduling is implemented by lines 16-41. This allocates time slots for each fᵢ on all switches of the subnetwork. Line 16 initializes a tuple FMTIᵢ^{src}^{ᵢ} of size numflow. Each element of the tuple presents a startup instant, at which time an fᵢ is transmitted from a TSN talker. Lines 17-41 maintain a loop that individually schedules the fᵢ over numflow iterations. Each iteration contains two sub-loops. The first is that of lines 21-40, which traverses every switch in subnetwork G′ so that an fᵢ can be scheduled on all switches. The second subloop (lines 35-39) guarantees that all the time slots required by a fᵢ are completely allocated at egress of a specific SWₖ.

The procedure will now be explained line by line. As mentioned earlier, the time slots are preferentially allocated to fᵢ with smaller φᵢ′. Therefore, the fᵢ with the smallest value of φᵢ′ will be popped from F′ using the heappop method. Then, the network delay experienced by fᵢ and the length of NTCI^{k} can be determined. Next, for a specific SWₖ in G′, a slot for that fᵢ is searched. In particular, by using the FindIndex( ) method, the first occurrence of −1 (which indicates that a time slot is available) in the tuple availableTS is sought. This is then updated to indexAvaliableTS, i.e., to the index of the first available time slot. Using the variable indexAvaliableTS, the specific position of the first available time slot in current T_{cycle} is determined. This position can be represented by the indexes (i.e., m and n) of the m-th TDI^{k} and n-th TS^{k} in T_{cycle}. In other words, in a T_{cycle}, the first available time slot is the n-th TS in the m-th TDI. In line 23, m is determined by rounding up the quotient of indexAvaliableTS and TSTCD. n is the remainder of index AvaliableTS and TSTCD. Next, FMTIᵢ^{SW}^{ₖ} is calculated by equation (15). The value of FMTIᵢ^{src}^{ᵢ} is temporarily saved by the auxiliary variable fmtiᵢ^{src}^{ᵢ} in line 26.

From lines 27-30, any transmission conflict at talker srcᵢ is checked and avoided. Specifically, line 27 checks if any element in FMTIⱼ^{src}^{ᵢ} is equal to fmtiᵢ^{src}^{ᵢ} arc which is computed in line 26. If so, transmission conflict is present; to resolve this, indexAvaliableTS is updated to plus one, implying that the time slot initially allocated to fᵢ is shifted to the next available slot. Then, rescheduling is triggered by executing the procedure commencing at line 22. If there is no transmission conflict, fmtiᵢ^{src}^{ᵢ} is updated to FMTIᵢ^{src}^{ᵢ} in line 31. Then, using the loop from lines 35-39, a time slot is allocated to fᵢ every slotInterval slots. Allocation will be terminated when all time slots required by an fᵢ are allocated. To implement this, the input parameters (lines 32-34) must be determined. First, the variable requiredTS is used to represent the number of time slots required by an fᵢ, as determined by

$$\frac{{T}_{cycle}}{{TSAI}_{i}} .$$

As mentioned earlier, a time slot is allocated to fᵢ every slotInterval slots. The slotInterval is calculated as

$$\frac{TSTCD \times \frac{{T}_{cycle}}{TDI}}{requiredTS} ,$$

where

$$( TSTCD \times \frac{{T}_{cycle}}{TDI} )$$

is the total number of time slots dedicated to transmission of the TC flows of a T_{cycle}. Finally, these parameters are fed into the loop of lines 35-39, which allocates all of the time slots required by fᵢ during T_{cycle}. In detail, the flow ID of fᵢ is updated to the indexAvaliableTS-th element of the tuple availableTS. This means that the indexAvaliableTS-th time slot is occupied by fᵢ. Then, allocateCNT is updated to plus 1 indicating that time-slot allocation has been performed once. Following this, the next time slot allocated to fᵢ is determined by adding slotInterval to indexAvaliableTS. The loop will not be terminated until allocateCNT is equal to the requiredTS, which means that time slots required by an fᵢ are completely allocated. The TSN schedules (GCLs) are generated in line 42 μsing the parameters calculated above.

### Configuration Procedure

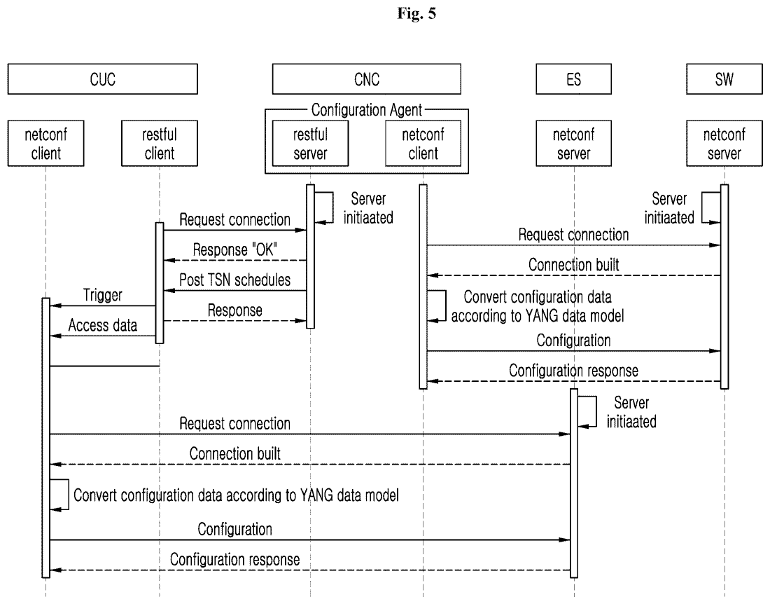

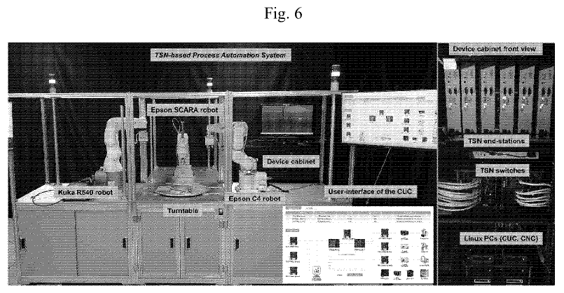

Configuration is performed jointly by the CNC and CUC; the CNC configures TSN SWs and the CUC configures ESs. FIG. 5 shows the sequence. Six components are involved (six boxes at the top). The arrows indicate information interaction between two objects. Self-messages are shown in the arrow [symbol] ; The texts on the arrows indicate that information is transferred from left to right and right to left, respectively. The Configuration agent (CA) routine of CNC is triggered when the scheduled results (GCLs and FMTIᵢ^{src}^{ᵢ}) are obtained. CA executes two internal sub-routines: RESTful server to transfer FMTIᵢ^{src}^{ᵢ} to the CUC, and netconf client to configure the GCLs as TSN SWs. Completion of scheduling initializes the CUC and CNC responsible for TSN configurations.

Next, the RESTful server and netconf server are discovered by the RESTful client of the CUC and netconf client of the CNC, respectively. When the connections are confirmed, the CNC immediately configures the SWs via two steps. First, pyang, a Python-based toolbox for the YANG data model, is used to transform the GCLs to XML-based configuration data. Second, the netconf client remotely configures the SWs by transmitting configuration data to the netconf server at the target SWs. In parallel, the RESTful server sends the scheduled FMTIᵢ^{src}^{ᵢ} data to the CUC via the POST method. When the CUC obtains the configuration data, the netconf client configures ESs. The CUC configuration procedure is identical to that of the CNC; CUC configuration will not be terminated until all ESs are configured.

### Experimental Deployment

Based on the above, a real-world TSN-based process automation system is constructed with the architecture shown in FIG. 3. The left side of FIG. 6 shows the entire system, and the right side shows the industrial TSN facilities. The system features three type-independent industrial robots (the Epson C4, Epson SCARA, and KUKA R540 robots) and one turntable. The turntable conveys an iron plate, and two of the three robots are selected in turns to execute successive pick-and-place tasks. Meanwhile, the third robot executes the waiting task, which requires the robot to wait for the trigger signal to switch the current task to the pick-and-place tasks. These TC applications are executed by four TSN talkers that generate the TC flows controlling the three robots and turntable. The traffic specifications are listed in Table 1. Specifically, four TC flows fᵢ of equal length (lᵢ=1,500 B) are periodically generated by talkers (pᵢ=1 ms). The delay constraint (φᵢ) of fᵢ is 1 ms, which indicates that fᵢ must be transmitted to the corresponding listener within 1 ms. All physical links have the same transmission speed (1 Gbps). To verify the TSM, we developed a traffic generator (TG) is developed to establish a high traffic load by adjusting the transmission interval. The interference traffic generated by the TG stresses the link between SW₁ and SW₂, which is shared by all traffic. Without effective scheduling, TC flows will be disturbed by massive interference traffic, compromising real-time service.

As shown on the right of FIG. 6, the device cabinet contains all TSN equipment, which is split into three layers. On the top layer, LS1028ardb boards serve as the TSN ESs that transmit or receive TC flows. In the middle, two Cisco switches (IE 4K) serve as TSN SWs switching both scheduled and unscheduled traffic according to the TSN schedules. NUC mini-PCs are contained in the bottom layer, wherein the CUC and CNC are executed. The CUC has a web-based user interface, as shown in the bottom right of FIG. 6; the network topology is that of FIG. 3. Open-source software was used as the TG and executed on an NUC PC to generate large amount of interference traffic. Hence, a high traffic load scenario is established to verify scheduling performance.

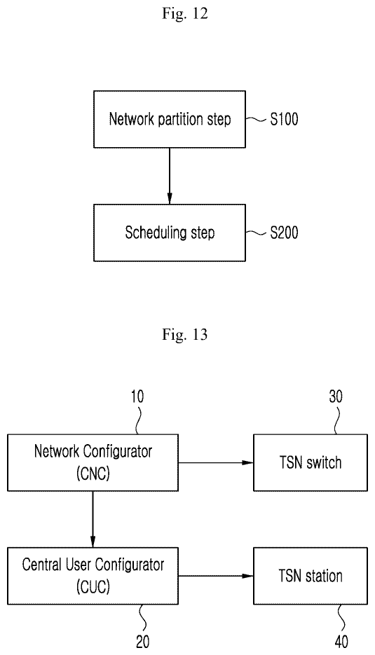

FIG. 12 illustrates the scheduling procedure in an industrial automation system in which the TSM according to the present invention is applied.

The procedure illustrated in FIG. 12 is executed in a control system of an industrial automation system, or in a separate computer device, and the scheduling results of each flow generated in the procedure are applied to the industrial automation system.

Specifically, the procedure illustrated in FIG. 12 is to optimize the operation management of the industrial automation system, and will be executed in a control device of the industrial automation system or in a processor of a separate computer device. Hereinbelow, description will be made by assuming that the procedure is executed by a processor.

Referring to FIG. 12, the TSM according to the present invention is largely divided into a network partition step (S100) and a scheduling step (S200).

The network partition step (S100) is a step to divide the network of the network topology into subnetworks.

The processor of industrial automation system executes network partition by dividing network into subnetworks based on the network topology G, traffic flow specification F and routing path (p_{(src}_{ᵢ}_{,dst}_{ᵢ}₎^{f}^{ᵢ}), and adjusting traffic flow specification F.

Specifically, the processor divides the network into subnetworks by acquiring the branch nodes by filtering the swiches that constitute the network topology, and by confirming whether the acquired branch nodes are included in the routhing path.

The scheduing step (S200) is a step to generate a schedule that determines the talker and the transmission start instant of each traffic flow included in the network topology.

The processor of industrial automation system executes the seheduling by determining the message transmission start instant (FMTIᵢ^{src}^{ᵢ}) and the GCL for opening or closing the switch (SW) on the routing path at a specific time, based on the subnetworks (G′), and adjusted traffic flow specifications (F′) and link specifications (link speed and length) calculated at the network partition step (S100).

Specifically, the processor calculates the time division interval (TDIk) with respect to the switch, and time slot number (TSTCDk) and time slot allotment interval (TSAIi) in which the time that constitutes the time division interval is alloted to the time critical interval (TCIk). The processor then allots the specific time slot of the time critical interval (TCIk) to each traffic flow to calculate the message transmission start instant (FMTIᵢ^{src}^{ᵢ}) of the talker and message transmission start instant of the switch on the routing path (FMTIᵢ^{SW}^{ₖ}). The processor then generates the GCL using the determined message transmission start instant.

FIG. 13 illustrates a schematic configuration of the control system of an industrial automation system to which the TSM of the present invention is applied.

Referring to FIG. 13, the control system of the present invention includes Central Network Configurator (CNC) (10) and Central User Configurator (CUC) (20).

The CNC (10) receives, as inputs, the network topology (G), and traffic flow specification (F) and link specification (link speed and length) to calculate the routing path (p_{(src}_{ᵢ}_{,dst}_{ⱼ}₎^{f}^{ᵢ} of each traffic flow. The CNC then generates the message transmission start instant (FMTIᵢ^{src}^{ᵢ}) of the talker (transmitter) and the GCL for opening or closing the switch (SW) on the routing path at a specific time, based on the routing path.

The CNC (10) converts the GCL into XML-based configuration data and transmits the converted data to the TSN switch (30), and transmits the message transmission start instant (FMTIᵢ^{src}^{ᵢ}) to the CUC (20) through the POST method.

The CUC (20) receives the message transmission instant of the talker (transmitter) from the CNC (10) and controls the message transmission movement of the TSN station (talker) (40).

### Performance Evaluation and Analysis

The numerical results of the real-world TSN-based process automation system is now being examined (FIG. 6). The system is configured by GCL derived using TSM and Cisco CNC software. Experiments were conducted on a PC with an Intel Core i7-8565U CPU and 16 GB of RAM. The TSM and Cisco CNC inputs were identical, so the network topology G={(ESᵢ,SWⱼ)|i=1, . . . ,8,j=1,2} (see FIG. 3) and traffic specifications F are the same as those in Table 1. The outputs of the Cisco CNC and TSM are the GCLs summarized in Tables 2 and 3, respectively, which specify the schedules for f₁-f₄. The tables contain the opening time-instants (T_{Open}^{v}^{ᵢ}) and closing time-instants (T_{Close}^{v}^{ᵢ}) for the prioritized queue. Specifically, at the egress of node vᵢ, transmission of fᵢ will commence at T_{Open}^{v}^{ᵢ} and end at T_{Close}^{v}^{ᵢ}. The remaining time is fully utilized to transmit non-TC flows.

TABLE 1
TSN Traffic specifications

| F | srcᵢ | dstᵢ | lᵢ | pᵢ | φᵢ |
|---|---|---|---|---|---|
| f₁ | Talker | Listener | 1,500 B | 1 ms | 1 ms |
| | Epson C4 | Epson C4 | | | |
| f₂ | Talker Epson | Listener Epson | 1,500 B | 1 ms | 1 ms |
| | SCARA | SCARA | | | |
| f₃ | Talker Kuka | Listener Kuka | 1,500 B | 1 ms | 1 ms |
| f₄ | Talker | Listener | 1,500 B | 1 ms | 1 ms |
| | Turntable | Turntable | | | |

TABLE 2
GCLs obtained from the Cisco CNC

| Schedule | | | | | | |
|---|---|---|---|---|---|---|
| (μs) | T_{Open}^{Src}^{ᵢ} | T_{Close}^{Src}^{ᵢ} | T_{Open}^{SW}^{₁} | T_{Close}^{SW}^{₁} | T_{Open}^{SW}^{₂} | T_{Close}^{SW}^{₂} |
| f₁ | 0 | 14 | 35 | 49 | 70 | 84 |
| f₂ | 0 | 14 | 935 | 949 | 984 | 998 |
| f₃ | 4 | 18 | 950 | 963 | 984 | 998 |
| f₄ | 4 | 18 | 49 | 63 | 84 | 98 |

TABLE 3
GCLs obtained from the traffic scheduling method

| Schedule (μs) | T_{Open}^{Src}^{ᵢ} | T_{Close}^{Src}^{ᵢ} | T_{Open}^{SW}^{₁} | T_{Close}^{SW}^{₁} | T_{Open}^{SW}^{₂} | T_{Close}^{SW}^{₂} |
|---|---|---|---|---|---|---|
| f₁ | 0 | 12.336 | 33.74 | 46.076 | 67.48 | 79.816 |
| f₂ | 12.336 | 24.672 | 46.076 | 58.412 | 79.816 | 92.152 |
| f₃ | 24.672 | 37.008 | 58.412 | 70.748 | 92.152 | 104.488 |
| f₄ | 37.008 | 49.344 | 70.748 | 83.048 | 104.488 | 116.824 |

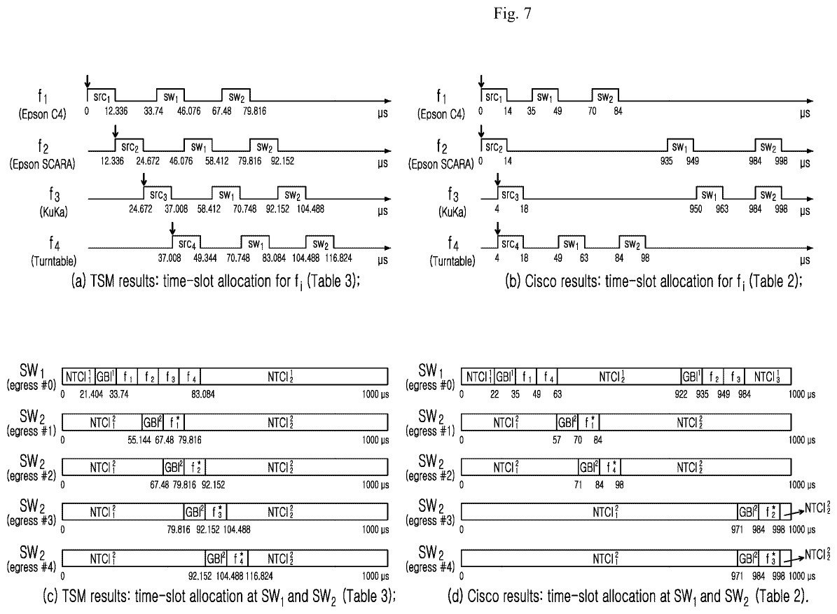

To facilitate understanding of the GCLs (Tables 2 and 3), the corresponding time slot allocation diagrams are presented in FIG. 7. Specifically, as shown in FIGS. 7(a) and 7(b), four timelines represent the schedules for fᵢ. Each timeline contains three boxes that indicate the time slot allocations at the TSN talkers (srcᵢ) and switches (SW₁ and SW₂). The rising and falling edges of each box are the time-instants of opening (T_{Open}^{v}^{ᵢ}) and closing (T_{close}^{v}^{ᵢ}), respectively, of the timed gates that transmit fᵢ. The arrow indicates the instant (FMTIᵢ^{src}^{ᵢ}) when fᵢ is generated; the transmission window is then immediately opened to send fᵢ out.

As shown in FIG. 7(a), the TSM calculates FMTIᵢ^{src}^{ᵢ} for each fᵢ, starting at 0 time-instant and increasing by 12.336 μs until the calculation is complete. Four dedicated time slots are continuously allocated to fᵢ to eliminate queuing delay and avoid transmission conflict. However, Cisco CNC randomly assigns an FMTIᵢ^{src}^{ᵢ} [FIG. 7(b)] to fᵢ at SW₁, which causes significant queuing delay, although the time-slot allocations do not overlap. The queuing delay is discussed later. The TSN listeners are connected to the individual ports of SW₂, which means that the TSN flows fᵢ do not compete for bandwidth resources. Hence, the TSM and Cisco CNC use the same policy to allocate time slots at SW₂; an appropriate slot is allocated when fᵢ is ready for transmission.

The bandwidth allocation scheme as described above has been used to plot fine-grained time slot allocation diagrams of SW₁ and SW₂. As shown in FIGS. 7(c) and 7(d), the slots appropriately transmitted both TC and non-TC flows within a hyper-period (1,000 μs). Allocation was repeated at intervals of 1,000 μs. As shown in FIG. 7(c), the TSM accurately calculates the NTCI^{k} and GBI^{k} μsing equations (4) and (6). When GBI^{k} finishes, TCI^{k} commences immediately, and successively allocates time slots (orange boxes) for transmission of fᵢ. This guarantees that TSN flow is timely; there is no queuing when SWs egress. For example, f₂ is generated at 12.336 μs and arrives at SW₁, and a time slot is promptly allocated when f₂ is ready for transmission at 46.076 μs. The remaining slots NTCI₂¹ are fully utilized by non-TC flows. However, as FIG. 7(d) shows, the Cisco CNC randomly assigns non-overlapping time slots for fᵢ. This avoids transmission conflicts but introduces substantial queuing delays. As an example, f₂ is generated at 0, and arrives at the egress of SW₁ after approximately 35 μs. However, f₂ is then queued until a slot is allocated at 935 μs. It is noted that both TSM and Cisco CNC allocate all remaining slots except TCI^{k} and GBI^{k} to NTCI^{k} so that the bandwidth can be fully utilized by non-TC traffic. Moreover, to fully eliminate the transmission interference, both TSM and Cisco allocate specific slots (see boxes marked with an asterisk) to TC traffic flows at egresses of SW₂, even TSN ESs are attached to the separate egresses of SW₂. Then, the performance of TSM and Cisco CNC is further evaluated by using the same inputs but gradually reducing the delay constraint (φᵢ) from 1 ms to 100 μs in steps of 10 μs.

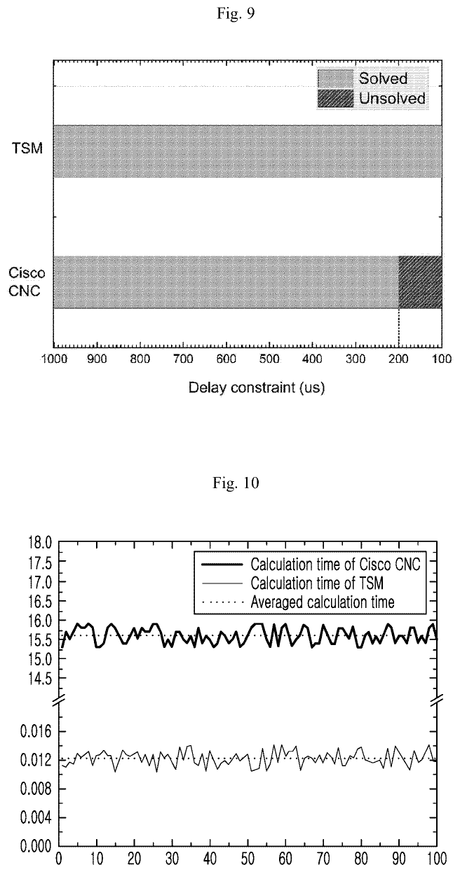

It is worth noting that φᵢ is assumed to be equal to the transmission period (pᵢ), so the values of pᵢ will also change as φᵢ changes. Therefore, 100 sets of comparison experiments were conducted, and for each set, TSM and Cisco CNC were executed to calculate the schedules. FIG. 9 plots the results, where grey boxes denote a valid TSN schedule can be obtained, whereas black dashed ones indicate a feasible schedule cannot be calculated. Specifically, the TSM can properly schedule TSN traffic when φᵢ varies from 1 ms to 100 μs. On the other hand, Cisco CNC can only schedule TSN traffic when φᵢ is higher than 200 μs. Once the φᵢ becomes tight, e.g., less than 200 μs, Cisco CNC cannot obtain a valid schedule due to starckOverFlowError is thrown, which is caused by the limitation of stack size. Afterwards, the performance of the TSM was compared with the Cisco CNC based on three key indicators: the end-to-end latency Tₑ₂ₑ, queuing delay T_{que}_{_{fi}}^{SW}^{ₖ}, and calculation time T_{cal}.

### End-to-End Latency

The end-to-end latency (Tₑ₂ₑ) is the transmission time of fᵢ from a talker (srcᵢ) to a listener (dstᵢ). Tₑ₂ₑ is critical for evaluating the real-time performance of industrial systems. ProfiShark 1G+ delay measurement devices have been used to measure Tₑ₂ₑ. Two devices were respectively deployed at the egress of the TSN talker and the ingress of the TSN listener. fᵢ was captured and timestamped T_{src}_{ᵢ} when it was transmitted by the talker. Then, fᵢ was timestamped again when it reached the ingress of the TSN listener (T_{dst}_{ᵢ}). Hence, Tₑ₂ₑ is expressed as:

$${T}_{e 2 e} = {T}_{{dst}_{i}} - {T}_{{src}_{i}} \qquad [ Equation 17 ]$$

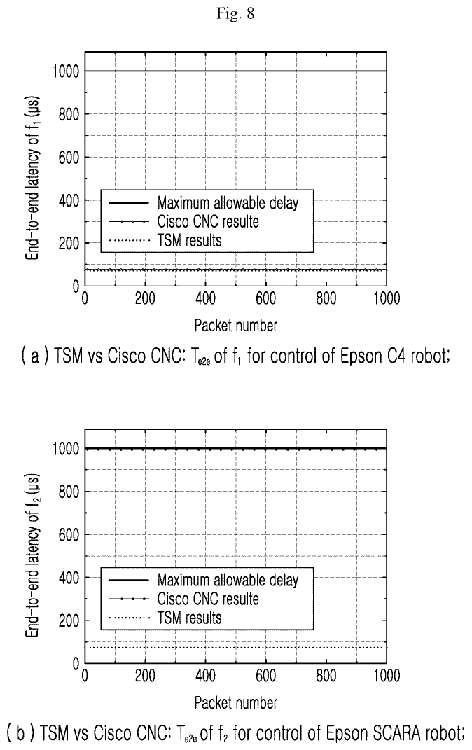

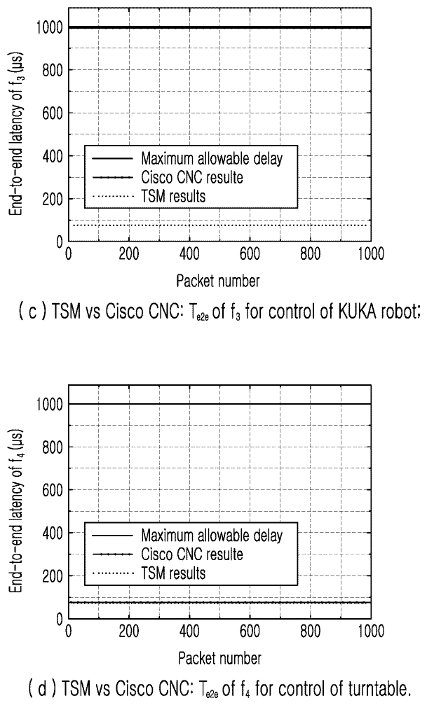

The Tₑ₂ₑ of the TSN testbed has been measured as described above. A total of 1,000 packets were captured during the peak traffic period, i.e., when the TG generated voluminous jamming traffic. In such a case, the shared link between SW₁ and SW₂ was completely occupied. The numerical Tₑ₂ₑ results are plotted in FIG. 8; the dotted lines and solid lines with dots are the Tₑ₂ₑ values of fᵢ scheduled by the TSM and Cisco CNC, respectively, and the solid lines are the Pi values. No measured Tele exceeds the Pi; both the TSM and Cisco CNC appropriately schedule fᵢ to satisfy real-time performance requirements. The Tₑ₂ₑ results of TSM and Cisco CNC in FIGS. 8(b) and 8(d) are quite similar. Because at the egress of SW₁, Cisco CNC allocations for f₁ (from 35 μs to 49 μs) and f₄ (from 49 μs to 63 μs) are coincidentally similar to those of the TSM, i.e., f₁ (from 33.74 μs to 46.076 μs) and f₄ (from 70.748 μs to 83.084 μs). But those of FIGS. 8(b) and 8(c) differ significantly because TSM eliminates queuing delays whereas Cisco CNC does not (see below).

### Queuing Delay

The queuing delay T_{que}_{_{fi}}^{SW}^{ₖ} is the time over which fᵢ is “stuck” in SWₖ, and is expressed as:

$${T}_{{que}_{{f}_{i}}}^{{SW}_{k}} = {T}_{Open}^{{SW}_{k}} - {D}_{phy}^{{src}_{i} {ToSW}_{k}} - {FMTI}_{i}^{sr {c}_{i}} - {T}_{{que}_{{f}_{i}}}^{{SW}_{k - 1}} \qquad [ Equation 13 ]$$

Here, T_{Open}^{SW}^{ₖ} is the instant when the gate opens to transmit fᵢ (i.e., at the egress of SWₖ). D_{phy}^{src}^{ᵢ}^{ToSW}^{ₖ} is the physical delay when fᵢ is transmitted from srcᵢ to SWₖ. FMTIᵢ^{src}^{ᵢ} is the start time of fᵢ transmission at talker srcᵢ. These three parameters were calculated above. T_{que}_{_{fi}}^{SW}^{ₖ₋₁} is the queuing delay experienced by fᵢ during its previous hop. It is assumed that T_{que}_{_{fi}}^{SW}^{ₒ} is 0 when k is 1. A larger T_{que}_{ᵢ}^{SW}^{ₖ} results in a greater end-to-end latency; Pi may be exceeded and real-time performance is not possible. Using Equation 18, the queuing delays has been calculated and summarized in Table 3. TSM eliminates these delays by carefully scheduling fᵢ, but the use of Cisco CNC is associated with significant delays; in particular, T_{que}_{_{f2}}^{SW}^{₁}, and T_{que}_{_{f3}}^{SW}^{₁} are both about 900 μs.

TABLE 4
Queuing delay results

| Scheduler | ${T}_{{que}_{{f}_{1}}}^{{SW}_{1}}$ | ${T}_{{que}_{{f}_{2}}}^{{SW}_{1}}$ | ${T}_{{que}_{{f}_{3}}}^{{SW}_{1}}$ | ${T}_{{que}_{{f}_{4}}}^{{SW}_{1}}$ | ${T}_{{que}_{{f}_{1}}}^{{SW}_{2}}$ | ${T}_{{que}_{{f}_{2}}}^{{SW}_{2}}$ | ${T}_{{que}_{{f}_{3}}}^{{SW}_{2}}$ | ${T}_{{que}_{{f}_{4}}}^{{SW}_{2}}$ |
|---|---|---|---|---|---|---|---|---|
| TSM | 0 | 0 | 0 | 0 | 0 | 0 | 0 | 0 |
| Cisco CNC | 1.26 | 901.26 | 912.26 | 11.26 | 1.26 | 15.26 | 0.26 | 1.26 |

### Calculation Time

The calculation time T_{cal} is the time between scheduler startup and calculation of a feasible TSN schedule. T_{cal} is important for operational performance in real industrial systems. Changes in product service requirements necessitate adjustments in service-oriented applications and network infrastructure. These changes may be frequent and the TSN schedule must be recalculated every time. Therefore, a TSN scheduler with a high T_{cal} is unacceptable. To measure T_{cal}, time is used, a popular Linux tool, which returns the elapsed time between invocation and termination of a program. Both TSM and Cisco CNC are used 100 times to schedule fᵢ on the TSN testbed. T_{cal} results has been plotted in FIG. 10, where X-axis denotes the running number, whereas Y-axis presents the calculation time in seconds. Thin solid and bold solid lines denote T_{cal} of Cisco CNC and the TSM, respectively. Dotted lines show the average values, i.e., 12.3 ms and 15.6 s, which are the averaged T_{cal} values of TSM and Cisco CNC, respectively. The TSM was much faster than Cisco CNC.

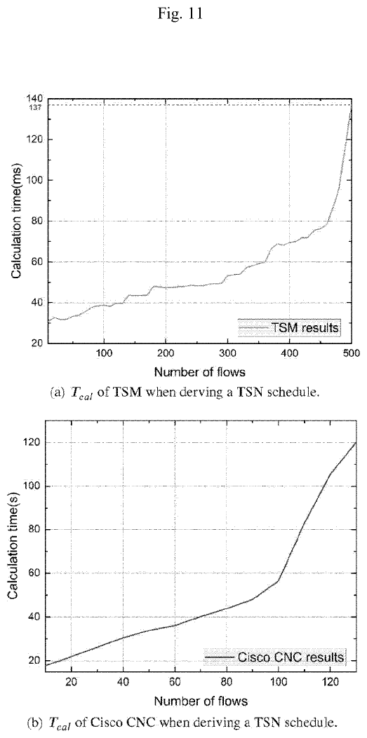

The effect of the number of input TSN flows on T_{cal} has been evaluated. The fᵢ flows has been input, where i ranged from 10 to 500 (step size=10), and generated 50 sets of cases. Each set contained 10 cases of different topologies, each of which was of the same network size (20 SWs and 60 ESs) but exhibited random connections. Hence, 500 cases were ultimately generated. NetworkX has been used to create the random topologies. The talkers srcᵢ and listeners dstᵢ were randomly distributed among the ESs. The flow size is 1,500 Bytes, flow period pᵢ was randomly selected from 4, 8, and 16 ms, and the deadline φᵢ was equal to the period. FIG. 11 plots the T_{cal} results, where the x-axis denotes the number of flows and the y-axis denotes T_{cal}, which increases with the number of flows.

Specifically, FIG. 11(a) shows that the TSM can schedule 500 flows within 137 ms. FIG. 11(b) shows that Cisco CNC schedules 120 flows in about 110 seconds. When the number of flows reaches 130, the Cisco CNC process is terminated because the starckOverFlowError switch is thrown; this is caused by the limitation of the stack size. To intuitively show how fast the TSM is than Cisco CNC, Table 4 is presented to show specific values of T_{cal} when flow numbers ranging from 10 to 120. T_{cal} of Cisco CNC has been divied by that of the TSM and present this value (i.e., x-fold) in the third column. For example, to schedule 10 TSN flows (see the first row of Table 4), the TSM needs 30.94 μs, while Cisco CNC requires 17.69 s Thus, the TSM is at least 571-fold

$$( \frac{17.69 s}{30.94 μs} )$$

faster than Cisco CNC. Moreover, when the network is fixed, the TSM can schedule more traffic flows.

TABLE 5
Calculation time (T_{cal}) comparison: TSM and Cisco CNC

| Flow numbers | TSM (μs) | Cisco CNC (s) | x-fold |
|---|---|---|---|
| 10 | 30.94 | 17.69 | 571-fold |
| 20 | 32.69 | 21.86 | 668-fold |
| 30 | 31.68 | 26.15 | 825-fold |
| 40 | 31.91 | 30.45 | 954-fold |
| 50 | 33.35 | 33.82 | 1014-fold |
| 60 | 34.00 | 36.04 | 1060-fold |
| 70 | 35.53 | 40.20 | 1131-fold |
| 80 | 37.83 | 43.81 | 1158-fold |
| 90 | 38.57 | 47.96 | 1243-fold |
| 100 | 38.78 | 56.45 | 1455-fold |
| 110 | 38.31 | 82.78 | 2160-fold |
| 120 | 39.72 | 105.41 | 2653-fold |

### Conclusion

The present invention develops the TSM to bridge the gap between theoretical research and practical implementation. Fine-grained guidelines that aid practical implementation of TSM has been presented. The present invention constructed a real-world TSN-based process automation system and specified the technical details. Finally, the TSM performance has been experimentally studied by measuring the end-to-end latency, queuing delay, and calculation time, and compared the TSM data to those of the Cisco CNC. Conclusions are as follows.

1) The TSM according to the present invention guarantees robust real-time performance for TC traffic flows, even when traffic loads are high.

2) The TSM eliminates queuing delays of TC traffic flows because scheduling is fine-grained.

3) When presented with 500 random cases, the TSM required only a very short computation time to generate a feasible schedule. The TSM was about 571-fold faster than the Cisco CNC.

In the future, the TSM will be extended to schedule incremental traffic during system runs. This will meet the flexible configuration requirements of various industry 4.0 applications (e.g., plug-and-produce application).

The above descriptions merely explain the present invention as an example, and various modification may be possible by an ordinary skill in the art in the technical field to which the present invention belongs without departing from the spirit of the present invention.

Accordingly, the embodiments of the specification in the present invention do not limit the scope of the present invention. The scope of the present invention should be interpreted by the claims below, and all technologies within the equivalent range should be interpreted to be included in the present invention.

### POSSIBILITY OF INDUSTRIAL USAGE

The present invention may be applied to various industrial communication where TSN (Time-Sensitive Networking) is applied.

1. A method performed in a control apparatus of an industrial automation system, the method comprising:
a step of performing a network partition by dividing a network into subnetworks and adjusting a traffic flow specification based on a network topology (G), traffic flow specification (F) and a routing path (p_{(src}_{ᵢ}_{,dst}_{ᵢ}₎^{f}^{ᵢ}); and
a scheduling step of determining a message transmission start instant (FMTIᵢ^{src}^{ᵢ}) and Gate Control List (GCL) for opening or closing a switch (SW) on a routing path at a specific time for each traffic flow, based on the subnetworks (G′), the adjusted traffic flow specifications (F′), and a link specification (link speed and length).

2. The method according to claim 1, wherein the step of performing the network partition includes:
acquiring a branch node by filtering a switch that constitutes the network topology, and
confirming whether the branch node is included in each routing path and dividing the network into subnetworks.

3. The method according to claim 1, wherein the scheduling step includes:
a procedure of determining a time division interval (TDIk) for the switch;
determining a time slot number (TSTCDK) and a time slot allotment interval (TSAIi) that are allotted to a time critical interval (TCIk) constituting the time division interval;
determining a message transmission start instant (FMTIᵢ^{src}^{ᵢ}) of a talker (transmitter) and a message transmission start instant of the switch (FMTIᵢ^{SW}^{ₖ}) on the routing path by allotting a specific time slot of the the time critical interval (TCIk) to each traffic flow; and
generating the Gate Control List (GCL) using the determined message transmission start instant of the switch determined.

4. A control system of an industrial automation system, the control system comprising:
a central network configurator (CNC) configured to:
receive, as inputs, a network topology (G), a traffic flow specification (F) link specification (link speed and length) to calculate a routing path (p₍ₛ_{_{rci}}_{,d}_{ₛₜᵢ}₎^{f}^{ᵢ}), and
generate a message transmission start instant (FMTIᵢ^{src}^{ᵢ}) of a talker (transmitter) and a Gate Control List (GCL) for opening or closing a switch (SW) on the routing path for each traffic flow based on the routing path,
a central user configurator (CUC) configured to:
receive a message transmission start instant of the talker (transmitter) from the CNC, and control a message transmission movement of the talker (transmitter).

5. The control system according to claim 4, wherein the CNC converts the GCL into XML-based configuration data to transmit to the switch (SW), and transmits the message transmission start instant (FMTIᵢ^{src}^{ᵢ}) to the CUC through a POST method.
